(19) United States
(12) Patent Application Publication
(10) Pub. No.: US 2017/0373295 A1
(43) Pub. Date: Dec. 28, 2017

(54) Separator Having Excellent Heat Resistance and Electrolyte Wetting Properties

(71) Applicant: SK Innovation Co., Ltd., Seoul (KR)

(72) Inventors: Hye Jin Kim, Daejeon (KR); Won Sub Kwack, Daejeon (KR); Min Sang Park, Daejeon (KR)

(21) Appl. No.: 15/628,958

(22) Filed: Jun. 21, 2017

(30) Foreign Application Priority Data
Jun. 23, 2016 (KR) 10-2016-0078702

(51) Int. Cl. H01M 2/16; H01M 2/14; H01M 10/0525; H01M 10/42

(52) U.S. Cl. CPC H01M 2/1646; H01M 10/4235; H01M 2/145; H01M 2/1686; H01M 10/0525

(57) ABSTRACT

A separator for a battery interposed between a cathode and an anode, and a method of manufacturing the same are provided, the separator for a lithium ion secondary battery including a porous polymer sheet having a first surface and a second surface opposing the first surface, and in which a pore communicating the first surface and the second surface is formed, and a heat resistant inorganic material layer coating at least the first surface and a surface of the pore, and formed in an atomic layer deposition method, wherein the heat resistant inorganic material layer formed on the first surface or the second surface has a thickness of 20 nm to 100 nm, porosity of the separator after the heat resistant inorganic material layer is formed is 30% to 70%, and a gurley value is 100 s/100 ml to 1000 s/100 ml.

### CROSS-REFERENCE TO RELATED APPLICATION

This application claims priority to Korean Patent Application No. 10-2016-0078702, filed Jun. 23, 2016, the disclosure of which is hereby incorporated in its entirety by reference.

### BACKGROUND

The present disclosure relates to a separator for a battery interposed between a cathode and an anode.

A general lithium ion secondary battery may include, for example, a cathode containing a lithium composite oxide, an anode containing a material capable of occluding and discharging a lithium ion, and a separator interposed between the cathode and the anode, and a non-aqueous electrolyte. The cathode and the anode are stacked with a separator interposed therebetween, or are wound after stacking, to form a wound electrode having a columnar form.

The separator serves to electrically insulate a cathode and an anode, and serves to support a non-aqueous electrolyte. As a separator of a lithium ion secondary battery, a porous polyolefin resin sheet is generally used. The porous polyolefin resin sheet has excellent electrical insulation and ion permeability characteristics, so the porous polyolefin resin sheet has been widely used as a separator within a lithium ion secondary battery, a capacitor, or the like.

A lithium ion secondary battery has a high power density and capacity density. However, an organic solvent may be used as a non-aqueous electrolyte, so a problem in which a non-aqueous electrolyte is decomposed and ignition occurs due to heat generation accompanying an abnormal state such as a short circuit, overcharging, or the like, may occur. To prevent the problem described above from occurring, when a battery causes abnormal heat generation, to allow pores of a separator to be closed through thermal melting of a resin material, or the like, so as to suppress ion conduction in a non-aqueous electrolyte, a porous polyolefin-based resin sheet such as polyethylene, or the like, having a low shutdown temperature, is used.

However, when shutdown is performed, since shrinkage of a membrane of a separator itself occurs together therewith, as a cathode and an anode are in contact with each other, a secondary problem such as an internal short, or the like may occur. Thus, as heat resistance of a separator is improved, it is necessary to reduce heat shrinkage and to improve safety at the same time.

For example, a separator having a coating layer, in which a glass layer is coated with a fine skeleton of a polyolefin-based resin, is described (Japanese Patent Publication No. 2009-16279). In addition, a separator for a battery in which an inorganic thin film is formed in a sol-gel method without occupying an empty hole in a surface of a polyolefin porous film is described (Japanese Patent No. 3797729). Moreover, a separator in which a thin inorganic oxide layer of 10 nm or less is deposited in an atomic layer deposition (ALD) in a surface of a porous polyolefin-based substrate and inside a pore is described (Japanese Patent Publication No. 2012-181921).

Meanwhile, the separator described in the above documents contributes to improved stability of a lithium ion secondary battery, but it is required to further improve battery characteristics such as high power density, capacity density, or the like as a separator for a lithium ion secondary battery. In order to improve battery characteristics described above, ion permeability should be high. To this end, it is necessary to have high wettability with respect to an electrolyte.

### SUMMARY

An aspect of the present disclosure may provide a separator having excellent battery stability, in which an electrolyte impregnation amount is increased by improving affinity to an electrolyte, and having excellent ionic conductivity.

According to an aspect of the present disclosure, a separator for a lithium ion secondary battery includes a porous polymer sheet having a first surface and a second surface opposing the first surface, and in which a pore communicating the first surface and the second surface is formed, and a heat resistant inorganic material layer formed in an atomic layer deposition method in the first surface or the second surface and a surface of the pore, wherein the heat resistant inorganic material layer formed on the first surface or the second surface has a thickness of 0.05% to 3% with respect to a thickness of the porous polymer sheet, porosity of the separator after the heat resistant inorganic material layer is formed is 30% to 70%, and a gurley value is 100 s/100 ml to 1000 s/100 ml.

The heat resistant inorganic material layer formed on the first surface or the second surface may have a thickness of 20 nm to 100 nm.

The heat resistant inorganic material layer formed in the pore of the porous polymer sheet may have a thickness of 5 nm to 50 nm.

The separator may have a deionized water contact angle of 80° or less.

The porous polymer sheet may have porosity of 20% to 80%.

The porous polymer sheet may be formed of a polyolefin-based resin, and the polyolefin-based resin may be selected from the group consisting of polyethylene (PE), polypropylene (PP), polymethylpentene (PMP), and polybutene-1 (PB-1).

The heat resistant inorganic material layer may include a molecule containing an atom of at least one metallic element selected from the group consisting of aluminum, calcium, magnesium, silicon, titanium, and zirconium, and an atom of at least one nonmetallic element selected from the group consisting of carbon, nitrogen, sulfur, and oxygen, and may be at least one selected from aluminum oxide, silicon oxide, titanium oxide, and zinc oxide.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a view conceptually illustrating a separator in which a heat resistant inorganic material layer is formed on a surface (one side or both sides) of a substrate and inside a pore of a substrate in an ALD method;

FIGS. 2A, 2B, 2C, and 2D are comparison images illustrating contact angles of a surface of a substrate, a surface (CCS) in which a substrate surface is coated with an inorganic layer, Comparative Example 1, and Example 1 in which a heat resistant inorganic material layer is formed inside a pore of a substrate, in an ALD method;

FIG. 3 is electrolyte wettability comparison images over time of Example 1, Comparative Example 1, and a separator sample (CCS) in which a substrate surface is coated with an inorganic layer; and

FIG. 4 illustrates results of a comparison of output characteristics for each charge/discharge cycle of a lithium ion battery manufactured using Example 1, Comparative Example 1, and a separator sample (CCS) in which a substrate surface is coated with an inorganic layer.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being ‘on,’ ‘connected to,’ or ‘coupled to’ another element, it can be directly ‘on,’ ‘connected to,’ or ‘coupled to’ the other element or other elements intervening therebetween may be present. In contrast, when an element is referred to as being ‘directly on,’ ‘directly connected to,’ or ‘directly coupled to’ another element, there may be no other elements or layers intervening therebetween. Like numerals refer to like elements throughout. As used herein, the term ‘and/or’ includes any and all combinations of one or more of the associated listed items.

It will be apparent that although the terms first, second, third, etc. may be used herein to describe various members, components, regions, layers and/or sections, any such members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as ‘above,’ ‘upper,’ ‘below,’ and ‘lower’ and the like, may be used herein for ease of description to describe one element's relationship relative to another element(s) as shown in the figures. It will be understood that spatially relative terms are intended to encompass different orientations of the device in use or operation, in addition to the orientation depicted in the figures. For example, if the device in the figures is turned over, elements described as ‘above,’ or ‘upper’ relative to other elements would then be oriented ‘below,’ or ‘lower’ relative to the other elements or features. Thus, the term ‘above’ can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms ‘a,’ ‘an,’ and ‘the’ are intended to include the plural forms as well, unless the context clearly indicates otherwise. It will be further understood that the terms ‘comprises,’ and/or ‘comprising’ when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present disclosure will be described with reference to schematic views illustrating embodiments of the present disclosure. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape results in manufacturing. The following embodiments may also be constituted alone, in combination or in partial combination.

The contents of the present disclosure described below may have a variety of configurations and only a required configuration is proposed herein, but the present invention is not limited thereto.

The present disclosure provides a separator of a lithium ion secondary battery in which a heat resistant coating layer is formed on a surface of a porous sheet in an ALD (atomic layer deposition) method.

A separator according to an embodiment includes a heat resistant inorganic material layer formed on a surface of a porous sheet using an atomic layer deposition method.

A separator according to an embodiment serves to allow a cathode and an anode to be isolated so as to prevent a short circuit as both poles are in contact with each other, and serves to allow a lithium ion to pass therethrough. In addition, the separator may be provided as a porous substrate formed of a material with high strength. The substrate has a first surface and a second surface opposing the first surface, and a porous polymer sheet including a plurality of pores communicating the first surface and the second surface may be suitably used in an embodiment.

More preferably, the substrate may typically be an insulating resin material having high ion permeability and a predetermined degree of mechanical strength. The resin material may be, for example, polyolefin resin such as polypropylene (PP), polyethylene (PE), polymethylpentene, polybutene-1, or the like, acrylic resin, styrene resin, polyester resin, polyamide-based resin, or the like. Among them, a polyolefin porous sheet has excellent electrical insulation and ion permeability, so the polyolefin porous sheet is widely used as a separator for the lithium ion secondary battery, or the like.

While the lithium ion secondary battery has high power density and capacity density, an organic solvent is used as a non-aqueous electrolyte. Thus, due to heat generation accompanying an abnormal heat generation state such as a short circuit, overcharging, or the like, the non-aqueous electrolyte may be decomposed. In the worst case, ignition may occur.

To prevent a phenomenon described above, when a battery is abnormally heated, a shutdown function of breaking a current by blocking a pore as the pore of a separator is thermally melted near a melting point of a resin material is required. Generally, as a shutdown temperature is lower, battery safety is higher. The polyolefin resin described above has an appropriate shutdown temperature, and thus may be suitably used as a separator of a lithium ion secondary battery. In addition, when a polyolefin-based porous sheet is used, separability between a cathode and an anode is excellent, so an internal short circuit or a decrease in an open circuit voltage maybe further reduced.

Such a polyolefin-based resin material is preferable in terms of a shutdown function described above. However, when shutdown is performed, a separator may be shrunk. Thus, a cathode and an anode are in contact with each other, so a secondary problem such as an internal short, or the like, may occur. Thus, a separator formed of a polyolefin resin material is required to reduce heat shrinkage by improving heat resistance, and to improve safety.

Here, in a separator according to an embodiment, to improve heat resistance of a substrate formed of a polyolefin-based resin so as to suppress shrinkage of the separator, a heat resistant inorganic material layer is included in a surface (on one side or both sides) of a substrate and an internal surface of a pore, by way of example.

The heat resistant inorganic material layer included in the substrate may be formed in an atomic layer deposition (ALD) method. As the heat resistant inorganic material layer is formed in an atomic layer deposition method, the heat resistant inorganic material layer may not only be formed on a surface of a substrate but also inside a pore.

When the heat resistant inorganic material layer is formed on a surface of a porous substrate, an ALD method according to the related art may be applied without limitation. In detail, with respect to a porous polymer sheet having a first surface and a second surface opposing the first surface, and including a plurality of pores communicating the first surface and the second surface, a metal compound vapor is supplied to the first surface and the second surface as well as an internal surface of the pore, so an inorganic layer of a metal compound is formed on a surface of a substrate due to a reaction of the substrate and the metal compound.

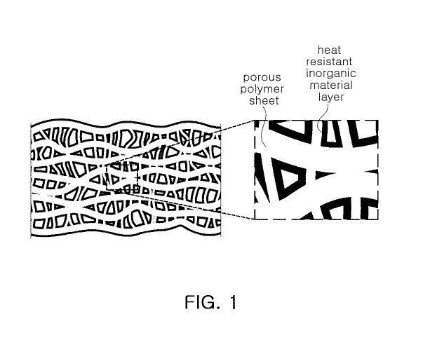

Due to an ALD method described above, the heat resistant inorganic material layer may be formed on a surface (one side or both sides) of a substrate and inside a pore of a substrate. The substrate in which a heat resistant inorganic material layer is formed on a surface and inside a pore is schematically illustrated in FIG. 1. As a heat resistant inorganic material layer is formed in an ALD method described above, in comparison with the case in which a porous inorganic film (ceramic coated) according to the related art is formed on a surface, a total thickness of a separator may be formed to be lower, so it is advantageous in terms of the capacity of a battery.

When a separator in which the heat resistant inorganic material layer is formed on a surface of a porous substrate is applied, even in an abnormal high temperature environment of a battery, the heat resistant inorganic material layer formed on a surface of a substrate may suppress heat shrinkage of a separator due to high adhesion with a polymer substrate surface. Thus, between a cathode and an anode, a separator is prevented from being shrunk by a high temperature, so a short circuit of an anode and a cathode may be suppressed.

In addition, in the case in which an ALD is performed, a heat resistant inorganic material layer is formed inside a pore of a porous polymer sheet. The heat resistant inorganic material layer has electrophilic properties with respect to an electrolyte. Thus, due to a heat resistant inorganic material layer formed even inside a pore, an impregnation amount of an electrolyte may be induced inside a pore, so an impregnation amount of an electrolyte of a separator may be increased. In this case, even when a gurley value is the same, ionic conductivity may be further improved. Here, a range of a gurley value may be extended in a range in which ionic conductivity does not decrease, so a secondary battery, which is safe while maintaining battery characteristics for a long time, may be implemented.

The heat resistant inorganic material layer is preferably formed of a material having superior heat resistance to that of a material forming a substrate. The heat resistant inorganic material layer is preferably formed of a molecule including an atom of at least one metallic element selected from the group consisting of aluminum, calcium, magnesium, silicon, titanium, and zirconium, and an atom of at least one nonmetallic element selected from the group consisting of carbon, nitrogen, sulfur, and oxygen. In more detail, the heat resistant inorganic material layer may be formed of at least one ceramic selected from aluminum oxide, silicon oxide, titanium oxide, and zinc oxide.

The heat resistant inorganic material layer described above is preferably formed in a range of 0.05% to 3% with respect to a thickness of a porous polymer sheet. When a thickness of a heat resistant inorganic material layer in a surface of the porous polymer sheet is less than 0.05% of a thickness of the porous polymer sheet, a thickness of a heat resistant inorganic material layer is thin, so an electrolyte impregnation amount is small. In addition, when a heat resistant inorganic material layer is not sufficiently formed inside a pore, so an impregnation amount increasing effect may not be obtained, the heat resistant inorganic material layer may not be sufficient to serve as a spacer when a battery is operated.

Meanwhile, when a thickness of a heat resistant inorganic material layer exceeds 3% with respect to a thickness of a porous polymer sheet, a deposition amount of a heat resistant inorganic material layer deposited inside a pore is significantly thick, so a pore may be blocked. Thus, a problem in which porosity required in a separator is not ensured may occur.

For example, the heat resistant inorganic material layer formed on a surface of the porous polymer sheet may have a thickness in a range of 20 nm to 100 nm. When the heat resistant inorganic material layer is formed to have a thickness in a range described above, the heat resistant inorganic material layer may be thickly formed even inside a pore. In this regard, when a battery is operated, the heat resistant inorganic material layer may serve as a spacer, so safety of a battery may be further enhanced.

As a thickness of an inorganic layer formed inside a pore increases, an impregnation amount of an electrolyte due to electrophilic properties increases. However, in order to ensure porosity required as a separator (a gurley value <1000 s/100 ml), a thickness of an inorganic layer formed inside a pore may not be indefinitely increased. Considering this, a thickness of the heat resistant inorganic material layer formed inside the pore is more preferably in a range of 5 nm to 50 nm.

As a heat resistant inorganic material layer formed on a surface of a separator has a thickness in a range described above, a heat resistant inorganic material layer is formed even inside a pore. In this case, affinity for an electrolyte of a separator is improved, and a contact angle with respect to an electrolyte may be significantly lowered. When affinity for the electrolyte is higher, electrolyte wettability is higher. Thus, ion permeability of a separator increases, so battery characteristics may be improved.

A degree of impregnation of an electrolyte may be evaluated by a contact angle using deionized (DI) water. Considering that polarity of a solvent used in an electrolyte is generally high, it may be determined that affinity with an electrolyte, polarity, is higher, when a contact angle with DI water, polarity, is lower.

In general, a DI water contact angle of a polyolefin separator is 100° to 130°, which has hydrophobic properties and electrolyte wettability is low. Thus, in order to improve wettability, a DI water contact angle is less than 100°, preferably less than 80°, and more preferably, less than 60°.

Meanwhile, a separator according to an embodiment, as described above, is desired to improve electrophilic properties by forming a heat resistant inorganic material layer with a thickness in a range described above, and not to block a pore. In other words, porosity of the separator in which a heat resistant inorganic material layer is formed is preferably 30% to 70%, and a gurley value is preferably in a range of 100 s/100 ml to 1000 s/100 ml.

In order to obtain a separator satisfying characteristics required as described above, porosity of a porous polymer sheet is preferably in a range of 20% to 80% and a gurley value is preferably in a range of 10 s/100 ml to 700 s/100 ml.

In a separator according to an embodiment, a heat resistant inorganic material layer is formed not only in a surface of a porous polymer sheet but also inside a pore, so ionic conductivity may be improved due to high affinity for an electrolyte as described above. Thus, even when a range of a gurley value is extended, battery characteristics may be maintained and safety of a battery may be ensured.

Formation of a heat resistant inorganic material layer in a surface of a porous polymer substrate in an ALD process may be performed by properly controlling ALD process conditions. It is not particularly limited, but a heat resistant inorganic material layer may be formed by properly controlling the injection time and purge time of a metal precursor, the injection time and purge time of an oxidant, the repetition number of an atomic layer deposition process, and the like, and may be formed by properly controlling a temperature inside a chamber when deposition is performed and a type of a metal precursor and an oxidant.

In detail, when the injection time and purge time of a metal precursor, the injection time and purge time of an oxidant, and the deposition repetition number are controlled as follows, formation of a heat resistant inorganic material layer not only in a surface but also in a pore may be smoothly performed.
Metal precursor injection time: 0.1 sec to 10 sec
Metal precursor purge time: 1 sec to 20 sec
Oxidant injection time: 0.1 sec to 10 sec
Oxidant purge time: 1 sec to 20 sec
Deposition repetition number: 10 times to 200 times

### EXAMPLES

Hereinafter, the present disclosure will be described in more detail with reference to the following Examples. However, these Examples are for illustrative purposes only, and the invention is not intended to be limited by these Examples.

### Example 1

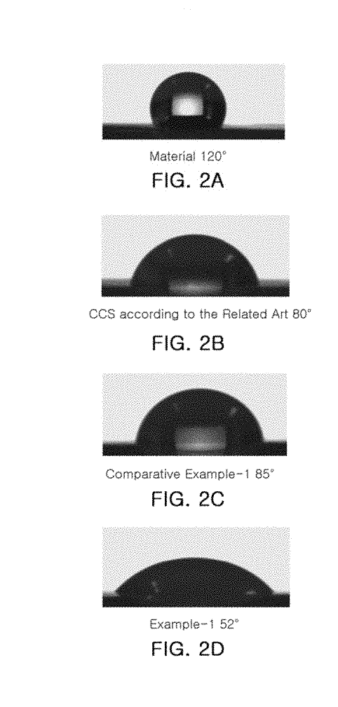

As illustrated in FIG. 2A, on a polyethylene substrate in which a DI water contact angle is 120°, an average pore size is 51 nm, porosity is 60%, and a thickness is 25 μm, as surface pretreatment for ALD deposition, a surface of a substrate was treated with 14 kV plasma at a rate of 3 m/min.

Trimethyl aluminum (Al(CH₃)₃) was injected for one second and was in contact with the substrate. After purging was performed for 5 seconds with argon (Ar), hydrogen peroxide (H₂O₂) was injected for 3 seconds as an oxidant, and a process of purging for 10 seconds with argon (Ar) again was repeated 100 times.

In this case, a temperature of an ALD chamber was fixed at 100° C.

When surface properties of a porous separator having been manufactured were measured, a thickness of an inorganic oxide layer formed on a surface of a porous separator was about 28 nm, porosity was 48%, a gurley value was 162 sec/100 cc. Further, when a DI water contact angle was measured and taken, the DI water contact angle was measured as 52° as illustrated in FIG. 2D.

### Example 2

On a polyethylene substrate in which an average pore size is 38 nm, porosity is 45%, and a thickness is 16 μm, as a surface pretreatment for ALD deposition, a surface of a substrate was treated with 12 kV plasma at a rate of 3 m/min.

Trimethyl aluminum (Al(CH₃)₃) was injected for one second and was in contact with the substrate. After purging was performed for 3 seconds with argon (Ar), H₂O₂ was injected for 2 seconds as an oxidant, and a process of purging for 10 seconds with argon (Ar) again was repeated 80 times.

In this case, a temperature of an ALD chamber was fixed at 100° C.

When surface properties of a porous separator having been manufactured were measured, a thickness of an inorganic oxide layer formed on a surface of a porous separator was about 23 nm, porosity was 36%, a gurley value was 257 sec/100 cc. In addition, a DI water contact angle was measured as 65°.

### Example 3

On a polyethylene substrate in which an average pore size is 42 nm, porosity is 52%, and a thickness is 20 μm, as a surface pretreatment for ALD deposition, a surface of a substrate was treated with 12 kV plasma at a rate of 3 m/min.

Diethyl zinc was injected for one second and was in contact with the substrate. After purging was performed for 5 seconds with argon (Ar), H₂O₂ was injected for 3 seconds as an oxidant, and a process of purging for 20 seconds with argon (Ar) again was repeated 120 times.

In this case, a temperature of an ALD chamber was fixed at 100° C.

When surface properties of a porous separator having been manufactured were measured, a thickness of an inorganic oxide layer formed on a surface of a porous separator was about 28 nm, porosity was 41%, a gurley value was 305 sec/100 cc. In addition, a DI water contact angle was measured as 78°.

### Comparative Example 1

On a polyethylene substrate in which an average pore size is 51 nm, porosity is 60%, and a thickness is 25 μm, as a surface pretreatment for ALD deposition, a surface of a substrate was treated with 14 kV plasma at a rate of 3 m/min.

Trimethyl aluminum (Al(CH₃)₃) was injected for one second and was in contact with the substrate. After purging was performed for 5 seconds with argon (Ar), hydrogen peroxide (H₂O₂) was injected for 3 seconds as an oxidant, and a process of purging for 10 seconds with argon (Ar) again was repeated 30 times.

In this case, a temperature of an ALD chamber was fixed at 100° C.

When surface properties of a porous separator having been manufactured were measured, a thickness of an inorganic oxide layer formed on a surface of a porous separator was about 19 nm, porosity was 57%, a gurley value was 103 sec/100 cc. In addition, a DI water contact angle was measured as 85° as illustrated in FIG. 2C.

### Comparative Example 2

On a polyethylene substrate in which an average pore size is 51 nm, porosity is 60%, and a thickness is 25 μm, as a surface pretreatment for ALD deposition, a surface of a substrate was treated with 14 kV plasma at a rate of 3 m/min.

Trimethyl aluminum (Al(CH₃)₃) was injected for one second and was in contact with the substrate. After purging was performed for 5 seconds with argon (Ar), hydrogen peroxide (H₂O₂) was injected for 5 seconds as an oxidant, and a process of purging for 5 seconds with argon (Ar) again was repeated 500 times.

In this case, a temperature of an ALD chamber was fixed at 100° C.

A thickness of an inorganic oxide layer formed on a surface of a porous separator having been manufactured was measured as about 102 nm, and porosity was 5%, and a gurley value could not be measured. A DI water contact angle was measured as 53°.

### Comparative Example 3

On a polyethylene substrate in which an average pore size is 35 nm, porosity is 41%, and a thickness is 20 μm, as a surface pretreatment for ALD deposition, a surface of a substrate was treated with 14 kV plasma at a rate of 3 m/min.

Trimethyl aluminum (Al(CH₃)₃) was injected for one second and was in contact with the substrate. After purging was performed for 5 seconds with argon (Ar), hydrogen peroxide (H₂O₂) was injected for 5 seconds as an oxidant, and a process of purging for one second with argon (Ar) again was repeated 100 times.

In this case, a temperature of an ALD chamber was fixed at 60° C.

A thickness of an inorganic oxide layer formed on a surface of a porous separator having been manufactured was measured as about 25 nm, porosity was 20%, and a gurley value was measured as 1005 sec/100 cc.

### Properties Evaluation

### —Electrolyte Wettability Evaluation—

As described above, in a separator according to an embodiment, an inorganic layer in which affinity to an electrolyte is high is formed on a surface of a polyethylene substrate, so a DI water contact angle is low as a result. In this regard, it is confirmed that wettability with respect to an electrolyte which is non-polar may be high.

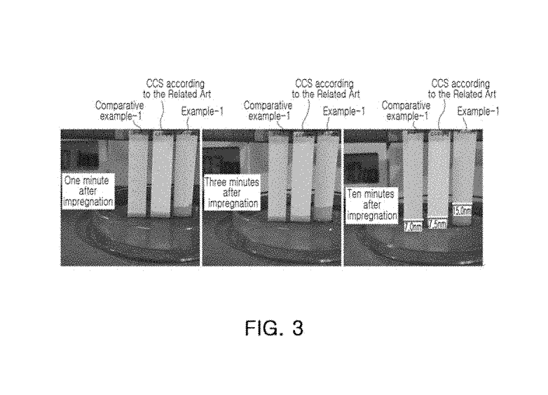

In addition, a separator according to Example 1, a separator according to Comparative example 1, and a ceramic coated separator according to the related art (CCS, it is referred to as a ‘CCS according to the related art’) are immersed in an electrolyte as illustrated in FIG. 3, and wettability of an electrolyte over time was compared.

In the case of CCS according to the related art, after a polyethylene substrate in which a DI water contact angle is 80°, as illustrated in FIG. 2B, an average pore size is 51 nm, porosity is 60%, and a thickness is 25 μm is surface-treated with plasma, a surface of a substrate is coated with a water-soluble binder containing an inorganic particle.

As seen from FIG. 3, in the case of a separator according to Example 1, it is confirmed that the separator is wetted to about 15 mm when 10 minutes elapse after the start of impregnation. However, in the cases of Comparative example 1 and CCS according to the related art, the separators are wetted to 7.0 mm and 7.5 mm, respectively. Thus, it is confirmed that the separator according to Example 1 has significant excellent wettability.

### —Battery Cycle Life—

A cycle life of a battery manufactured using a separator according to Example 1, a separator according to Comparative example 1, and CCS according to the related art is confirmed through a charging and discharging experiment.

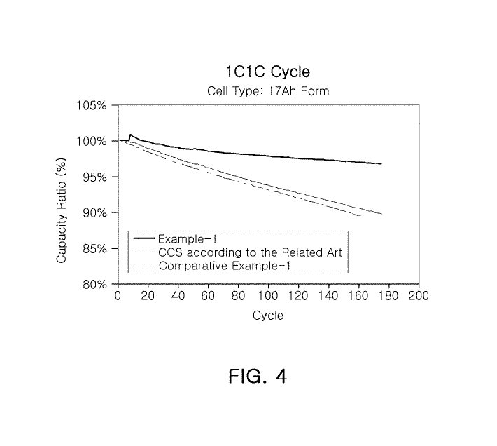

Each separator is used to manufacture a battery having 17.7 Ah. A battery having been manufactured is evaluated while charging/discharging 180 times under conditions of a rate 1 C/1 C. A result thereof is illustrated in FIG. 4.

As seen from FIG. 4, in a battery using a separator according to Example 1, in comparison with batteries using a separator according to Comparative example 1 and CCS according to the related art, it is confirmed that a reduction in capacity as a charge/discharge cycle progresses is significantly small. Here, in a separator according to Example 1, wettability of an electrolyte is good. Thus, even when a charge/discharge cycle progresses, a large amount of an electrolyte is impregnated in a pore of a separator, so capacity efficiency is excellent.

As set forth above, according to an exemplary embodiment, while characteristics as a separator for a lithium ion secondary battery are not lowered, heat resistance is excellent and electrolyte wettability is improved. Thus, battery characteristics such as power density, capacity density, and the like, of a lithium ion secondary battery may be improved.

While exemplary embodiments have been shown and described above, it will be apparent to those skilled in the art that modifications and variations could be made without departing from the scope of the present invention as defined by the appended claims.

What is claimed is:

1. A separator for a lithium ion secondary battery comprising:
a porous polymer sheet having a first surface and a second surface opposing the first surface, and in which a pore communicating the first surface and the second surface is formed; and
a heat resistant inorganic material layer formed on the first surface or the second surface and a surface of the pore in an atomic layer deposition method,
wherein the heat resistant inorganic material layer formed on the first surface or the second surface has a thickness of 0.05% to 3% with respect to a thickness of the porous polymer sheet, porosity of the separator after the heat resistant inorganic material layer is formed is 30% to 70%, and a gurley value is 100 s/100 ml to 1000 s/100 ml.

2. The separator of claim 1, wherein the heat resistant inorganic material layer formed on the first surface or the second surface has a thickness of 20 nm to 100 nm.

3. The separator of claim 1, wherein the heat resistant inorganic material layer formed in the pore of the porous polymer sheet has a thickness of 5 nm to 50 nm.

4. The separator of claim 1, wherein a deionized water contact angle of the separator is 80° or less.

5. The separator of claim 1, wherein porosity of the porous polymer sheet is 20% to 80%.

6. The separator of claim 1, wherein the porous polymer sheet is formed of a polyolefin-based resin.

7. The separator of claim 6, wherein polyolefin of the polyolefin-based resin is selected from the group consisting of polyethylene, polypropylene, polymethylpentene, and polybutene-1.

8. The separator of claim 1, wherein the heat resistant inorganic material layer comprises a molecule including an atom of at least one metallic element selected from the group consisting of aluminum, calcium, magnesium, silicon, titanium, and zirconium, and an atom of at least one nonmetallic element selected from the group consisting of carbon, nitrogen, sulfur, and oxygen.

9. The separator of claim 8, wherein the heat resistant inorganic material layer is at least one selected from aluminum oxide, silicon oxide, titanium oxide, and zinc oxide.
